(19) United States
(12) Patent Application Publication
(10) Pub. No.: US 2012/0271714 A1
(43) Pub. Date: Oct. 25, 2012

(54) RETARGETING RELATED TECHNIQUES AND OFFERINGS

(75) Inventors: Ayman Farahat, San Francisco, CA (US); Tarun Bhatia, Simi Valley, CA (US)

(73) Assignee: Yahoo! Inc., Sunnyvale, CA (US)

(21) Appl. No.: 13/093,498

(22) Filed: Apr. 25, 2011

(51) Int. Cl. G06Q 30/00

(52) U.S. Cl. 705/14.53

(57) ABSTRACT

The present invention provides techniques including determining or providing guaranteed delivery advertising offers or products based at least in part on advertisement retargeting related information, such as predicted, forecasted, or assessed advertisement retargeting serving opportunities over a period of time. Historical user online activity information may be obtained, patterns leading to retargeting opportunities may be determined, and, based at least on the determined patterns, a prediction or assessment may be made of future retargeting opportunity availability. Guaranteed delivery advertising offers or products, or parameters thereof, may be determined based at least in part on the prediction or assessment.

### BACKGROUND

“Retargeting” is a term that may be used to describe certain types of advertising targeting techniques. Retargeting can include, among other things, targeting a user with an advertisement based at least in part on an activity of the user, such as visiting a particular Web site, which activity is no longer occurring or current, but which occurred relatively recently in the past. The user may not be targeted, and served, an advertisement during the user's visit to the particular Web site, for example, but may be instead in a sense retargeted after the user's visit or activity. Typically, retargeting takes place proximately enough in time so that the retargeting is sufficiently likely to be effective based on, for example, the previous Web site visit. This may be important since, often, the degree of effectiveness of advertising based on a user activity, such as a Web site visit, may tend to drop off as the amount of time that has elapsed between the activity and the advertising increases.

As an example, retargeting may be used for users who are presently visiting a relatively low (advertising) value, high inventory Web site or property type, but have recently visited a high value, low inventory site. For instance, users who are visiting an auto shopping site may be very effectively targeted with auto ads, but there may be relatively little (and expensive) inventory of serving opportunities to such users. On the other hand, it may be observed that users who visit a relatively high inventory, low value Web site or property, such as, for example, an email site, within a certain period of time from when the user visited (or was sufficiently active on, etc.) an auto shopping site, may still be effectively targeted with auto ads based on their recent auto shopping site visit. As such, users visiting the high inventory, low value email site shortly after visiting the high value, low inventory auto shopping site may, for example, may present excellent retargeting opportunities.

There is a need for new techniques including use of retargeting in online advertising.

### SUMMARY

Some embodiments of the invention provide systems and methods including determining or providing guaranteed delivery advertising products based at least in part on advertisement retargeting related information, such as predicted, forecasted, or assessed advertisement retargeting serving opportunities over a period of time.

Some embodiments of the invention recognize and mine patterns of past user behavior, which can include online and offline behavior, to determine, or probabilistically or statistically predict or assess with a certain degree of certainty, future retargeting inventory availability. Such predictions or assessments can then be used in order to practically, profitably, or optimally offer, or determine terms, pricing or other parameters of, guaranteed delivery advertising offers or products to advertisers or proxies of advertisers, which offers or products may include retargeted advertising.

In some embodiments, historical user online activity information is obtained and used to determine patterns in user activity that generate or provide advertisement retargeting opportunities, which may be used in making a prediction or assessment as to advertisement retargeting opportunity availability over a future period of time. The prediction or assessment may be used in determination of one or more guaranteed delivery advertising offers to be offered to advertisers or proxies of advertisers. Determination of the one or more guaranteed delivery advertising offers may include, for example, determining quantity, pricing, time period, or other parameters associated with guaranteed delivery advertising packages or products.

In some embodiments, mining user activity patterns to predict future advertisement retargeting opportunity availability can allow, or allow determination of, offerings of associated guaranteed delivery advertising products.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

Herein, the term “advertiser” is intended to broadly include advertisers as well as their proxies, agents, affiliates, etc.

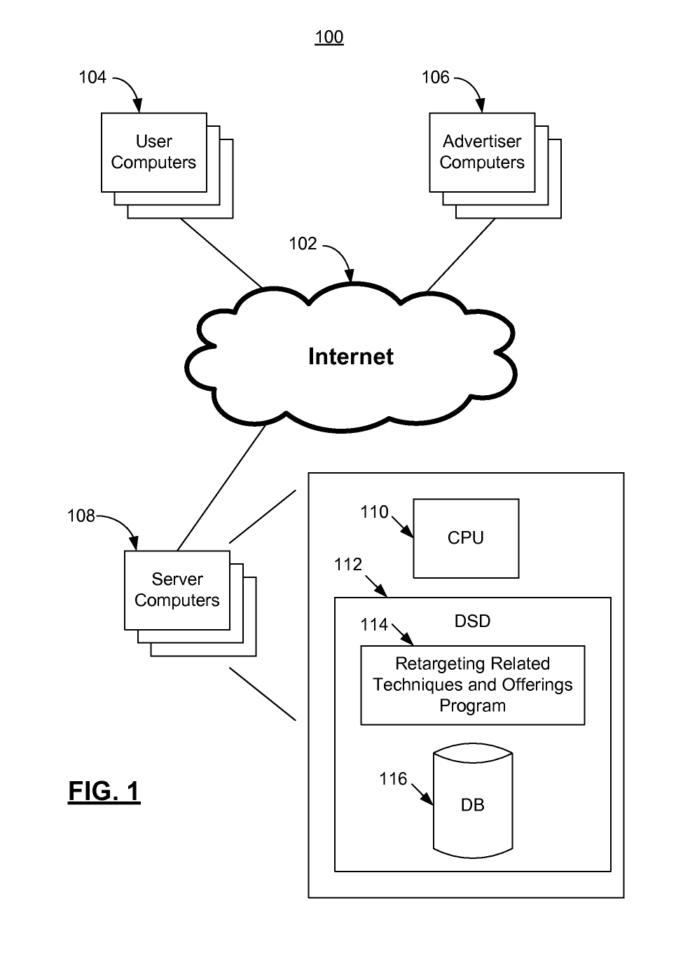

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, mobile advertisements, coupons or group discounts, social networking associated advertisements, etc.

As depicted, each of the server computers 108 includes one or more CPUs 110 and a data storage device 112. The data storage device 112 includes a database 116 and a Retargeting Related Techniques and Offerings Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

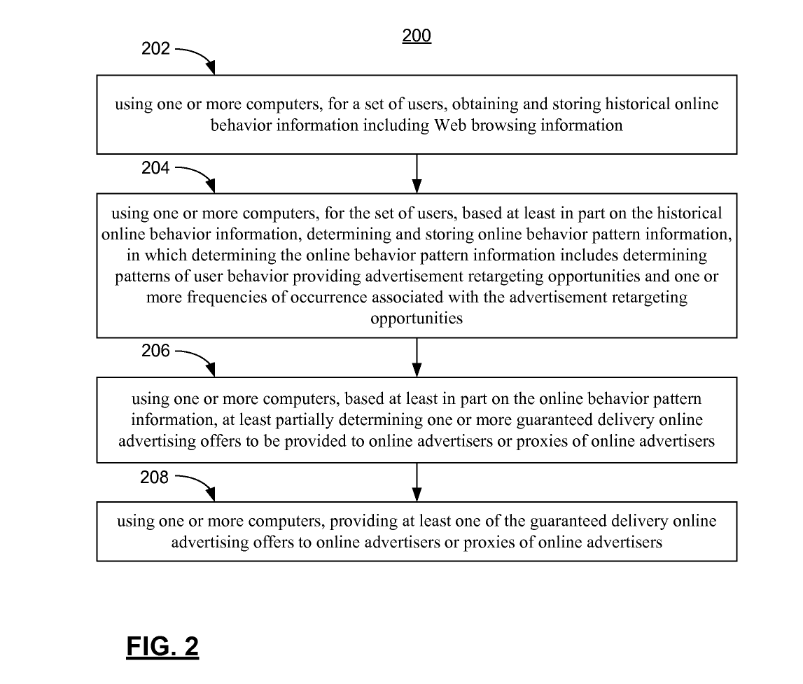

FIG. 2 is a flow diagram illustrating a method 200 according to one embodiment of the invention. At step 202, using one or more computers, for a set of users, historical online behavior information is obtained and stored, including Web browsing information.

At step 204, using one or more computers, for the set of users, based at least in part on the historical online behavior information, online behavior pattern information is determined and stored. Determining the online behavior pattern information includes determining patterns of user behavior providing advertisement retargeting opportunities and one or more frequencies of occurrence associated with the advertisement retargeting opportunities.

At step 206, the method 200 includes, using one or more computers, based at least in part on the online behavior pattern information, at least partially determining one or more guaranteed delivery online advertising offers to be provided to online advertisers or proxies of online advertisers.

At step 208, the method 200 includes, using one or more computers, providing at least one of the guaranteed delivery online advertising offers to online advertisers or proxies of online advertisers.

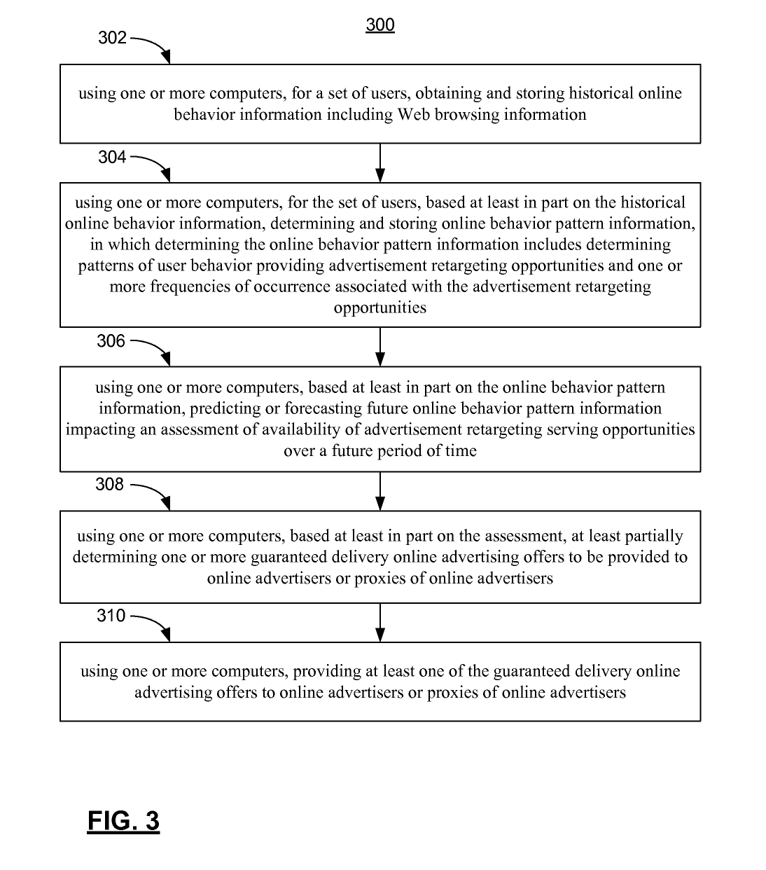

FIG. 3 is a flow diagram illustrating a method 300 according to one embodiment of the invention. Steps 302 and 304 are similar to steps 202 and 204 of the method 200 depicted in FIG. 2.

At step 306, the method 300 includes, using one or more computers, based at least in part on the online behavior pattern information, predicting or forecasting future online behavior pattern information impacting an assessment of availability of advertisement retargeting serving opportunities over a future period of time.

In some embodiments of the invention, various types of prediction or forecasting may be made, incorporated or used. For example, in some embodiments, predictions or forecasts may be made as to reach and frequency of retargeting opportunities. Furthermore, predictions or forecasting may be made and used regarding retargeting inventory in relation to time factors or windows, or by time lag, e.g., one hour since visiting finance versus one day, etc. Still further, predictions or forecasting may be made or used regarding retargeting inventory performance relative to original, originally anticipated, or non-retargeted targeting performance, e.g., for cell phones advertised to finance retargets on mail one day later, or in connection with a certain frequency of exposure, or both, the conversion rate may be, for example, one half of the conversion rate for showing the same advertisement on finance.

At step 308, the method 300 includes, using one or more computers, based at least in part on the assessment, at least partially determining one or more guaranteed delivery online advertising offers to be provided to online advertisers or proxies of online advertisers.

At step 310, the method 300 includes, using one or more computers, providing at least one of the guaranteed delivery online advertising offers to online advertisers or proxies of online advertisers.

Although described largely with reference to guaranteed delivery advertising, some embodiments of the invention are used with various types of advertising, including guaranteed delivery advertising, non-guaranteed delivery advertising, or both. For example, in some embodiments, pattern determination, prediction or forecasting, such as in connection with inventory or proxy inventory, may be used in connection with non-guaranteed delivery advertising, spot market advertising, or predetermined probability advertising, such as advertising or advertising offers or products including predetermined probabilities associated with providing retargeting impressions, etc. Additionally, in some embodiments, an advertising product or offer may be determined based at least in part on determined or predicted relative performance of a counterpart product or offer without benefit of techniques according to embodiments of the invention, such as without pattern determination and usage, for example. Furthermore, in some embodiments, any of various known or standard analytic techniques may be used, such as in determining or discovering the alternative retargeting products, such as for relative performance determinations, etc.

Additionally, H mention that the pricing of the GD product could be determined or based at least in part on a determined or predicted relative performance of a counterpart GD product without benefit of the invention

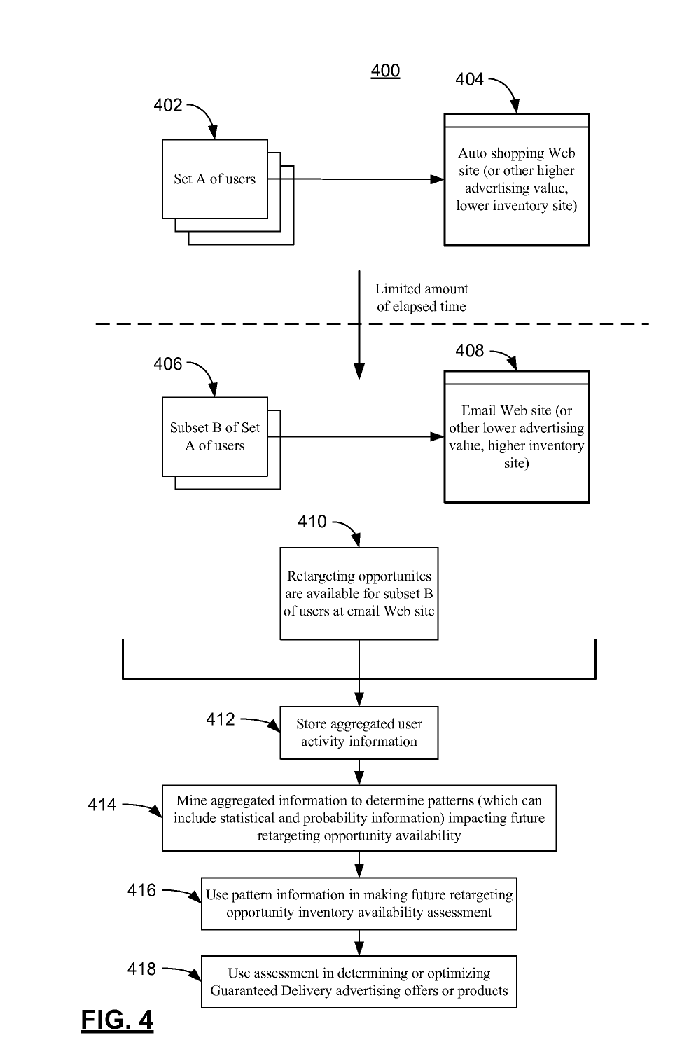

FIG. 4 is a block diagram 400 illustrating one embodiment of the invention. As depicted, a Set A 402 of users visit, or visit and sufficiently interact with, a higher advertising value, lower inventory Web site, such as an auto shopping Web site 404.

After a period of time has elapsed, up to a certain limit, a Subset B 406 of users, of Set A, are then depicted visiting, or visiting and interacting with, a lower advertising value, higher inventory Web site, such as an email Web site 408. As depicted by block 410, retargeting opportunities may exist for the Subset B users visiting the email Web site.

As depicted by block 412, aggregated user activity information, including activities leading to retargeting opportunities, is stored, such as in one or more databases.

As depicted by block 414, the aggregated information, along with perhaps other information, is mined to determine patterns (which can include statistical and probability information) impacting future retargeting opportunity availability. The patterns can include or be temporal patterns, or patterns with a temporal aspect, for example.

As depicted by block 416, determined pattern information is in making a future retargeting opportunity inventory availability assessment.

As depicted by block 418, the assessment is used in determining or optimizing guaranteed delivery advertising offers or products.

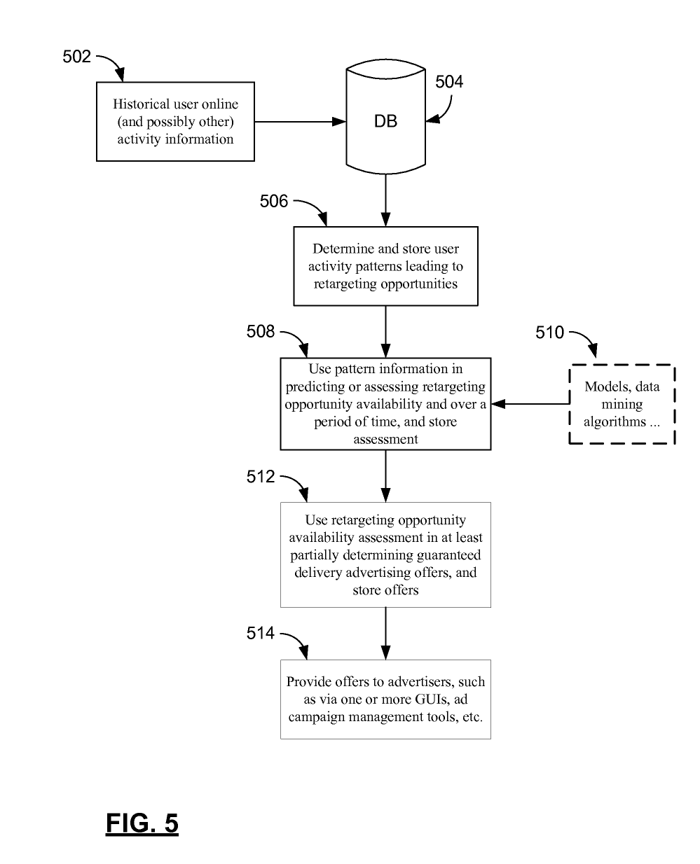

FIG. 5 is a block diagram 500 illustrating one embodiment of the invention.

Block 502 represents historical user online (and possibly other, such as offline) activity information, which may be collected and stored in a database 504.

Block 506 represents determining and storing user activity patterns leading to retargeting opportunities.

Block 508 represents using pattern information in making a prediction or assessment of retargeting opportunity availability and over a period of time, and storing the prediction or assessment. As depicted by block 510, this may include use of various models, such as machine learning models, data mining algorithms, other algorithms or tools, etc.

Block 512 represents using the retargeting opportunity availability assessment in at least partially determining guaranteed delivery advertising offers, and storing the offers or offer parameters or information.

In some embodiments, guaranteed delivery advertising relates to advertising in accordance with guaranteed delivery agreements or contracts. In some embodiments, for example, guaranteed delivery advertising relates to agreements with advertisers in which the advertisers are assured or guaranteed, perhaps subject to some payment or other compensation if the guarantee is not met, that, for some cost to the advertiser, specified advertising will be delivered to users over a future period of time so as to meet some specified measure of advertising or advertisement performance. In some embodiments, for example, in guaranteed delivery, an advertiser may be promised or guaranteed a certain amount of specified advertising or a specified performance measure, based on future advertisement delivery, such as a number of impressions, numbers conversions, an amount of measured brand engagement, or various other measured parameters or combinations thereof. Failure to deliver the guaranteed quantity or measure may lead to some compensation or penalty that must be provided to or paid to the advertiser, etc.

Block 514 represents providing offers to advertisers or proxies of advertisers, such as via one or more GUIs, ad campaign management tools, etc.

Some embodiments of the invention mine patterns of past user behavior to determine, or probabilistically or statistically predict or assess with a certain degree of certainty, future retargeting inventory availability. Such predictions or assessments can then be used in order to practically or optimally offer, or determine terms, pricing or other parameters of, guaranteed delivery advertising offers or products to advertisers or proxies of advertisers, which offers or products may include retargeted advertising. For example, having a certain degree of certainty that a certain amount of a certain type of retargeting inventory will be available during a certain future period of time may allow practically, profitably, or optimally offering guaranteed delivery products to advertisers accordingly.

Some embodiments include leveraging usage patterns of users on the Internet, such as to identify advertising opportunities which may include guaranteed delivery retargeting, such as site retargeting, opportunities.

Some embodiments include a recognition that users can and do exhibit well defined patterns as they engage with the Internet at large. User patterns can occur at multiple resolutions. For example, a user might first go to a general Web portal in the morning and a social networking site in the evening. While on the Web portal, the user might first check email and then might typically go to the finance page, for example.

In some embodiments, well defined temporal patterns can be used in online advertising. For example, suppose that a user visits a mobile phone site with offers for mobile phone plans. Five minutes later the same user visits an email site. The user has signaled an interest in mobile, so it makes sense to display a mobile phone ad, even while the user is at the email site. This can be an example of retargeting. Some embodiments of the invention mine user behavior patterns to make predictions regarding future retargeting inventory availability, which can include quantity, and determine and provide guaranteed delivery products utilizing such predictions.

Some embodiments include a recognition that, for example, across some large Web portal properties, which can include finance, email, etc., enough information is available to recognize patterns and make good or sufficient retargeting inventory predictions. Furthermore, such patterns may be well-defined or consistent. As such, repeatable usage patterns, for example, may be recognized. For example, it may be determined that, generally or with a certain degree of confidence, that some significant percentage, perhaps 40%, of finance property visitors go on to visit an email property within 24 hours.

In some embodiments, patterns such as repeatable usage patterns can make possible sufficient prediction of a number of retargeting opportunities, such as during a future period of time. Predicting the number of retargeting opportunities can allow, for example, an advertising exchange or network, or an entity associated with an advertising exchange or network, to sell certain advertising inventory as targeted guaranteed delivery that meets retargeting type of criteria.

Guaranteed delivery advertising can have various advantages over non-guaranteed. This can include advantages to various involved parties, including an advertising network or exchange or other seller, an advertiser or proxy of an advertiser purchasing the guaranteed delivery product, various other ecosystem participants, and even the ecosystem as a whole, in terms of overall efficiency, optimization, etc. Some embodiments of the invention allow guaranteed delivery advertising that would otherwise not be available, providing, for example, better optimization of inventory utilization and profitability for an advertising network or exchange, better campaign performance or return on investment for advertisers, etc.

While the invention is described with reference to the above drawings, the drawings are intended to be illustrative, and the invention contemplates other embodiments within the spirit of the invention.

1. A method comprising:
using one or more computers, for a set of users, obtaining and storing historical online behavior information comprising Web browsing information;
using one or more computers, for the set of users, based at least in part on the historical online behavior information, determining and storing online behavior pattern information, wherein determining the online behavior pattern information comprises determining patterns of user behavior providing advertisement retargeting opportunities and one or more frequencies of occurrence associated with the advertisement retargeting opportunities;
using one or more computers, based at least in part on the online behavior pattern information, at least partially determining one or more guaranteed delivery online advertising offers, or one or more predetermined probability advertising offers, to be provided to online advertisers or proxies of online advertisers; and
using one or more computers, providing at least one of the one or more guaranteed delivery online advertising offers to online advertisers or proxies of online advertisers.

2. The method of claim 1, comprising, based at least in part on the online behavior pattern information, predicting or forecasting future online behavior pattern information impacting an assessment of availability of advertisement retargeting serving opportunities over a future period of time, and, based at least in part on the assessment, providing at least one of the one or more guaranteed delivery online advertising offers to online advertisers or proxies of online advertisers.

3. The method of claim 1, comprising, wherein the online behavior pattern information comprises temporal pattern information, and, based at least in part on the online behavior pattern information, predicting or forecasting available advertisement retargeting serving opportunity inventory over a period of time.

4. The method of claim 1, comprising, based at least in part on the online behavior pattern information, predicting or forecasting available advertisement retargeting serving opportunity inventory over a period of time, and comprising, based at least in part on predicted or forecasted available advertisement retargeting serving opportunity inventory, at least partially determining the one or more guaranteed delivery online advertising offers to be provided to online advertisers or proxies of online advertisers.

5. The method of claim 1, comprising, based at least in part on the online behavior pattern information, predicting or forecasting available advertisement retargeting serving opportunity inventory over a period of time, including determining probability information associated with the available advertisement retargeting serving opportunity inventory.

6. The method of claim 1, wherein providing the at least one of the one or more guaranteed delivery online advertising offers to online advertisers or proxies of online advertisers comprises providing inventory specification and pricing information associated with a guaranteed delivery online advertising product or package.

7. The method of claim 1, wherein providing the at least one of the one or more guaranteed delivery online advertising offers to online advertisers or proxies of advertisers comprises providing inventory specification and pricing information associated with a guaranteed delivery online advertising product or package including a specified quantity or degree of impressions, conversions, or brand engagement.

8. The method of claim 1, wherein advertisement retargeting comprises targeting a user with an advertisement based at least in part on Web-related status or Web-related activity of the user which is not occurring during the targeting of the advertisement but which was occurring within a particular period of time prior to the targeting.

9. The method of claim 1, wherein advertisement retargeting comprises targeting a user on a relatively low advertising value, high inventory Web site or property based at least in part on information that the user has visited a relatively high advertising value, low inventory property within a specified period of time from the targeting.

10. The method of claim 1, comprising providing the at least one of the one or more guaranteed delivery online advertising offers to online advertisers or proxies of advertisers via one or more graphical user interfaces.

11. A system comprising:
one or more server computers coupled to a network; and
one or more databases coupled to the one or more server computers;
wherein the one or more server computers are for:
for a set of users, obtaining and storing historical online behavior information comprising Web browsing information;
for the set of users, based at least in part on the historical online behavior information, determining and storing online behavior pattern information, wherein determining the online behavior pattern information comprises determining patterns of user behavior providing advertisement retargeting opportunities and one or more frequencies of occurrence associated with the advertisement retargeting opportunities;
based at least in part on the online behavior pattern information, at least partially determining one or more guaranteed delivery online advertising offers to be provided to online advertisers or proxies of online advertisers; and
providing at least one of the one or more guaranteed delivery online advertising offers to online advertisers or proxies of online advertisers.

12. The system of claim 11, comprising providing at least one of the one or more guaranteed delivery online advertising offers to online advertisers or proxies of online advertisers via one or more graphical user interfaces.

13. The system of claim 11, comprising, based at least in part on the online behavior pattern information, predicting or forecasting future online behavior pattern information impacting an assessment of availability of advertisement retargeting serving opportunities over a future period of time.

14. The system of claim 11, comprising, based at least in part on the online behavior pattern information, predicting or forecasting available advertisement retargeting serving opportunity inventory over a period of time.

15. The system of claim 11, comprising, based at least in part on the online behavior pattern information, predicting or forecasting available advertisement retargeting serving opportunity inventory over a period of time, and comprising, based at least in part on the predicted or forecasted available advertisement retargeting serving opportunity inventory, at least partially determining the one or more guaranteed delivery online advertising offers to be provided to online advertisers or proxies of online advertisers.

16. The system of claim 11, comprising, based at least in part on the online behavior pattern information, predicting or forecasting available advertisement retargeting serving opportunity inventory over a period of time, including determining probability information associated with the available advertisement retargeting serving opportunity inventory.

17. The system of claim 11, wherein providing the at least one of the one or more guaranteed delivery online advertising offers to online advertisers or proxies of online advertisers comprises providing inventory specification and pricing information associated with a guaranteed delivery online advertising product or package.

18. The system of claim 11, wherein providing the at least one of the one or more guaranteed delivery online advertising offers to online advertisers or proxies of advertisers comprises providing inventory specification and pricing information associated with a guaranteed delivery online advertising product or package including a specified quantity or degree of impressions, conversions, or brand engagement.

19. The system of claim 11, wherein advertisement retargeting comprises targeting a user with an advertisement based at least in part on Web-related status or Web-related activity of the user which is not occurring during the targeting of the advertisement but which was occurring within a particular period of time prior to the targeting.

20. A computer readable medium or media containing instructions for executing a method comprising:
using one or more computers, for a set of users, obtaining and storing historical online behavior information comprising Web browsing information;
using one or more computers, for the set of users, based at least in part on the historical online behavior information, determining and storing online behavior pattern information, wherein determining the online behavior pattern information comprises determining patterns of user behavior providing advertisement retargeting opportunities and one or more frequencies of occurrence associated with the advertisement retargeting opportunities;
using one or more computers, based at least in part on the online behavior pattern information, predicting or forecasting future online behavior pattern information impacting an assessment of availability of advertisement retargeting serving opportunities over a future period of time;
using one or more computers, based at least in part on the assessment, at least partially determining one or more guaranteed delivery online advertising offers to be provided to online advertisers or proxies of online advertisers; and
using one or more computers, providing at least one of the one or more guaranteed delivery online advertising offers to online advertisers or proxies of online advertisers.
